(19) United States
(12) Patent Application Publication
(10) Pub. No.: US 2013/0346331 A1
(43) Pub. Date: Dec. 26, 2013

(54) METHODS AND SYSTEMS FOR ASYMMETRIC EXCHANGE OF CONTENT

(71) Applicant: Olocode Limited, London (GB)

(72) Inventors: Giuliano Giovannetti, Richmond (GB); Pierre Brais, London (GB)

(21) Appl. No.: 13/917,166

(22) Filed: Jun. 13, 2013

Related U.S. Application Data
(60) Provisional application No. 61/662,647, filed on Jun. 21, 2012.
(60) Provisional application No. 61/681,334, filed on Aug. 9, 2012.
(60) Provisional application No. 61/703,023, filed on Sep. 19, 2012.
(60) Provisional application No. 61/723,394, filed on Nov. 7, 2012.

(51) Int. Cl. G06F 17/30; G06Q 10/10

(52) U.S. Cl. CPC G06F 17/30283; G06Q 10/105
USPC 705/320; 707/758

(57) ABSTRACT

The invention discloses systems and methods for managing contact information with simple alphanumeric codes. The alphanumeric code can be used to distribute a library of relevant content, e.g., contact information, and to easily update the information when the content changes. The alphanumeric code can be controlled by an individual, or the alphanumeric code may be controlled by an entity, such as a business. In an embodiment, an entity can use the alphanumeric codes to assure that it maintains communication with contacts developed by its employees.

### RELATED APPLICATIONS

This application claims priority to U.S. Provisional Patent Application No. 61/662,647 filed Jun. 21, 2012, U.S. Provisional Patent Application No. 61/681,334 filed Aug. 9, 2012, U.S. Provisional Patent Application No. 61/703,023 filed Sep. 19, 2012, and U.S. Provisional Patent Application No. 61/723,394 filed Nov. 7, 2012, all of which are incorporated by reference in their entireties.

### FIELD OF THE INVENTION

The invention relates to methods and systems for managing and exchanging content, e.g., contact information such as telephone numbers, e-mail addresses and geographic locations. A user of the system selects a unique alphanumeric code and all of the content is correlated to the code. The code allows for seamless content updating, for example changes in contact information due to job changes or moves.

### BACKGROUND

According to the U.S. Bureau of Labor Statistics, the typical American professional worker changes jobs every 5.4 years. The average tenure varies substantially with age, running from about 3 years per job for workers in their 30s, to about 10 years per job for workers in their 50s. See United States Department of Labor, Bureau of Labor Statistics, 2012 Employee Tenure Summary, incorporated herein by reference in its entirety.

A job change typically causes a significant modification of a worker's contact information. A job change results in changes to physical work address, work e-mail address, and daytime phone number. Additionally, in many cases, the job change requires a residential move, e.g., to a new city or a new state, and results in a new home address and phone number. In some instances, a relocating worker may also obtain a new mobile phone number.

The contact information updates that accompany a job change present difficulties for the employee, as well as the employee's former and new employers. The employee and the former employer have invested time and resources into building a network of business contacts to coordinate sales of goods and/or services provided by the former employer. In some cases, the loss of important contacts creates animosity between the employee and the former employer. The new employer, on the other hand, is eager to leverage the business contacts of the new employee in order to drive their sales of goods and/or services. Sometimes, the inability of a new employee to maintain the employee's former contacts can make the new employer feel that the employee has not “delivered” the benefits that the employee was expected to bring to his/her new job.

The business contact problems above are amplified by the nature of modern communication and the number of employees that do not have traditional roles. An employee may be working as a consultant, and have multiple different e-mail addresses to monitor and respond to each day. Employees may also be “headquartered” at one location, but actually work from another physical location or from home. In such cases, a job change may involve changes to ten to twenty contact items. Typically, a worker will send out a mass “new contact info” e-mail to his/her distribution list after starting the new job. For a recipient of such an e-mail, however, the time required to update all of the contact items is formidable, and may result in the “new contact info” e-mail getting lost, e.g., buried in the inbox, never to be recovered.

Social media websites, such as FACEBOOK® or LINKEDIN®, can help people remain in contact with their business contacts after a job change. However, these services require a contact to execute several tasks prior to accessing updated contact information, such as logging in, searching for the contact, copying the new contact information, and then pasting the new contact information into a contact management system, such as MICROSOFT OUTLOOK®. Furthermore, the ability to update a contact is contingent upon the person owning the account updating his/her profile regularly with the new information. Furthermore, employers do not typically have the ability to view, track, or modify their employees' profiles on social media websites. Thus, an employer that spent resources developing the contacts of its former employee, e.g., expense accounts and meeting registrations, may be left in the cold, i.e., without the ability to reconnect with the former employee's contacts.

### SUMMARY

The invention addresses many of the shortcomings of modern contact info management by associating a unique alphanumeric code with content. The content may be information relating to a person, an asset (i.e., a house for sale) or an event. For example, the content can be a person's contact information. The content could also be information about the time and place of an event. In an embodiment, this system allows a person to quickly transmit all of their contact information by handing out the alphanumeric code, whereby a recipient can retrieve the person's contact information by entering the code, e.g., into a website. Furthermore, if the option is selected, the recipient can receive updated contact information from the person indefinitely. Thus, both the person and the recipient of the code will not have to worry that they might “lose touch” if the either changes contact info. In other embodiments, a recipient of the alphanumeric code can receive automatic updates, for example, if the time or location of an event is changed.

The invention also addresses the difficulty of typing a long URL or email address on a mobile device having small keys or a touchscreens. e.g., to access the information associated with an A/N code. The user can simply send a blank email to a short email address associated with the A/N code and receive in response the contact details associated with that A/N code. The user email address may also be associated with the A/N code (i.e., a “follower”) and sent updates whenever the contact details associated with the A/N code are modified.

The invention also addresses the difficulty that employers face when an employee leaves, or is promoted. Rather than have a customer receive the annoying “she doesn't work here anymore” response, the customer's contact info for the employee is automatically updated with the contact info of the employee's replacement. In other instances, the customer will receive an automated message informing them of the change prior to changing the contact information. Accordingly, an employer can easily provide uninterrupted service to its customers and reassure its customers when they receive the “new contact info” e-mail from the former employee.

In another aspect, methods and systems to facilitate secure logins, e.g., using a mobile device, are disclosed. The method allows a user to avoid having to type in a user name and password when interacting with a website on a mobile device. Instead, the user simply sends an auto-generated message to a server associated with the website, whereupon the server verifies the address and the device identity, and sends a return message to the user with a hyperlink to the logged-in website. The user merely activates the hyperlink in the message and then continues using the website as if the user had logged-in normally, e.g., through the login page.

### BRIEF DESCRIPTION OF DRAWINGS

FIG. 1 is a flow chart depicting a process for selecting a unique alphanumeric code and associating the code with contact information of a user;

FIG. 2 illustrates an exemplary system of the invention for creating, modifying, and managing codes associated with contact information;

FIG. 3 is a flow chart depicting a recipient interfacing with a system to obtain contact information associated with a code;

FIG. 4 is an exemplary interface for entering a code in order to retrieve the contact information associated with the code;

FIG. 5 is an exemplary confirmation screen showing that an entered code is valid;

FIG. 6 depicts an exemplary interface for choosing a format for retrieving the contact information associated with a code;

FIG. 7 depicts an exemplary contact management program that has been updated with contact information retrieved with a code;

FIG. 8 is a flow chart depicting a user updating contact information and the subsequent distribution of the updated contact information via messaging;

FIG. 9 depicts an autogenerated message containing a vCard with updated contact information;

FIG. 10 depicts an exemplary personal address book that displays contacts that are associated with unique alphanumeric codes;

FIG. 11 illustrates relationships between the owner of a code, the owner's contacts, and the owner's employer, also having control over one of the owner's codes;

FIG. 12 is a flow chart depicting a method for forwarding a code of a first user to contact information of a second user;

FIG. 13 is a flow chart depicting a method for securely logging into a website via message exchange with a device;

FIG. 14 illustrates an exemplary system of the invention for securely logging into a website via message exchange with a device.

### DETAILED DESCRIPTION

The invention discloses systems and methods for managing content, e.g., contact information, with simple alphanumeric codes (“A/N code,” generally). The A/N code can be used to distribute a library of relevant content, e.g., contact information, and to easily update the content when it changes. The A/N code can be controlled by an individual, or the A/N code may be controlled by an entity, such as a business. In an embodiment, an entity may choose to use the A/N codes to assure that it maintains communication with contacts developed by its employees.

An A/N code is an alphanumeric string of 5 to 15 characters, chosen from the system alphabet (which may contain both numbers and letters but exclude some symbols like O which is similar to 0). An example of a 6-character A/N code is “AO74DW”.

### A/N Code Registration

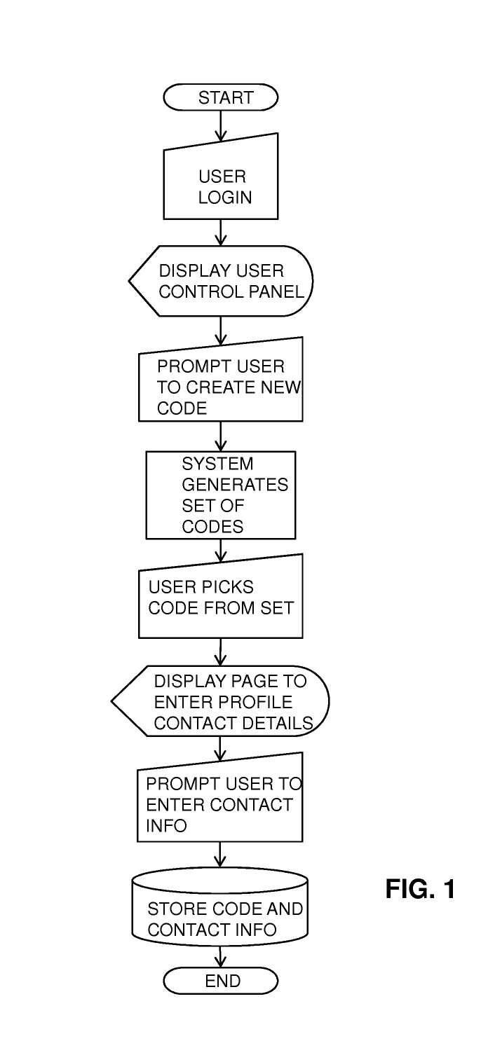

A user registers for an A/N code using the steps depicted in FIG. 1. Registration is typically done on a computer system or mobile device, and includes a choice of login and password, collection of basic details (name, etc.) and email address. The e-mail address is verified by sending an account activation link to the email address. If the link is not followed, the account is not active and no functionality can be deployed. Users can have one or more email addresses associated with their account. In this way, if one of them becomes unavailable (for example if it was a corporate email address and the user changes company) it is still possible to send messages to the user.

After registration, an A/N code string is generated by the system. The system can generate a set of strings, e.g., ten strings, and the user can choose the one he likes best, after which the remaining strings are destroyed. The system only allows strings that are different from any previously registered A/N code. The system may require that one of more characters in the string represent a control character, such as a checksum character at the end of the string to recognize if a typing mistake has been made.

The systems prevents generating A/N codes of a given length (number of characters) once a given saturation ratio has been reached. (Saturation ratio=number of active A/N codes/number of possible A/N codes given the alphabet and the length of the string. For example, using only 26 letters, and strings of length 5, the possible A/N codes are 26⁵ or 11,881,376. If the chosen saturation ratio is 5%, then only 594,068 A/N codes of length 5 will be generated by the system.) A low saturation level makes it more difficult for an attacker of the system to “harvest” the database by generating a lot of failed requests. (The system can implement a slow response (even of a few seconds) to each request so as to slow down any attempt to harvest data.) A high number of mistakes originating from the same computer can also be used to identify and isolate an attacker so that the system will no longer answer its requests.

When used to manage contact information, a different contact profile is associated to each A/N code, and such profile can be edited by its owner. A user could have more than one profile (and associated A/N code), for example one for his personal details, one for his business details in one country and one for his other business in another country. Each profile contains personal contact details, for example home and business addresses, home and business telephone numbers, mobile phone numbers, e-mail addresses and personal websites, and possibly other fields such as social media addresses, preferred websites, etc. Users can modify their profile at any time. It is also possible that a registered user maintains the A/N code on behalf of a set of other individuals. For example, a user could be a company administrator and she may maintain the A/N codes and corresponding profiles for all the company employees.

The association between the A/N code and the contact information is stored as a user account. A user account may contain a number of attributes including: username, email address(es), billing details, list of owned A/N codes, list of other people A/N codes retrieved with the additional option of whether to remain informed or not of updates to such A/N codes (also called the Personal Address Book, or PAB), usage statistics, list of other users following this user A/N codes.

The chosen A/N code and the associated contact information are recorded in a database for later retrieval by the user or by contacts of the user who use the A/N code to access the user's contact information. A user wishing to retrieve the profile information associated with an A/N code will enter the A/N code at the system website (described in further detail below) at which point the system will compare the A/N code to the database to retrieve the profile information. In some instances, a user will be able to directly modify the database by entering or modifying his/her user profile, using, for example a website or an application for a phone.

In some instances, the database will be modified by an administrator having the ability to enter or modify profiles and also to associate A/N codes with each other. An administrator will be able to modify profiles and associate A/N codes with each other using, for example a website or an application for a phone. Some organizations may wish to control their employees' use of A/N codes. In such instances, the A/N code may contain all or a portion of the name (or internet domain name) of the organization, as described in greater detail below. Any request to create a profile with an email address belonging to such registered domain will have to be approved (automatically or manually) by the registered owner of the domain.

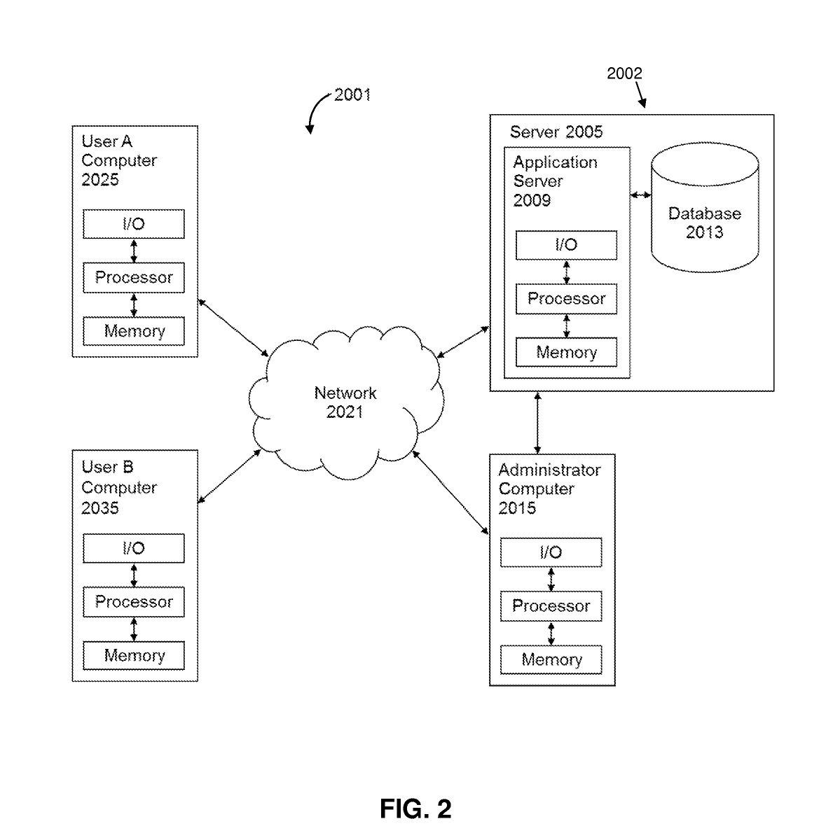

The architecture 2001 for managing contact information using the methods described in the invention is shown in FIG. 2. A system 2002 comprises a processor, input and output connection(s), and memory. The memory contains instructions to carry out the methods of the invention. The system 2002 may reside on a server 2005 that comprises both an application server 2009 and a database 2013, or the application server 2009 and the database 2013 may be located on different platforms. Using a communications network 2021, which can be either a computer network or a phone network or some other network, the system 2002 is able to communicate with users and/or administrators, for example User A Computer 2025, User B Computer 2035, and Administrator Computer 2015. Thus it is possible for the users to register with the system 2002 and also to receive information from the system 2002. It is to be understood that User A Computer 2025, User B Computer 2035, and Administrator Computer 2015 do not have to be desktop computers but could be client terminals, laptops, phones, tablets, or some other mobile device.

Once a registered user (A) has chosen an A/N code and filled in his contact details in the associated profile, the user will communicate his A/N code to his contacts whenever he needs to provide his contact details. This can be done, for example, by printing the A/N code on his business card, or writing it in an email as part of A's email signature or simply giving it orally over the phone or in person. Rather than simply writing the A/N code, user A may alternatively provide a hyperlink containing the A/N code in the form of a URL, such as http://get.A/N code.com/ABC123 or in HTML format something like <a href=“http://get.A/N code.com/ABC123”> Get an updated vCard for A/N code ABC123 </a>. This would be treated in accordance with the UID field definition in the vCard standard, i.e. a URL that leads to an updated version of the details display page (DDP). In this way a recipient of A's A/N code has no need to retype the system address or code in his browser, allowing him to immediately reach an updated version of A's contact details.

### A/N Code Retrieval

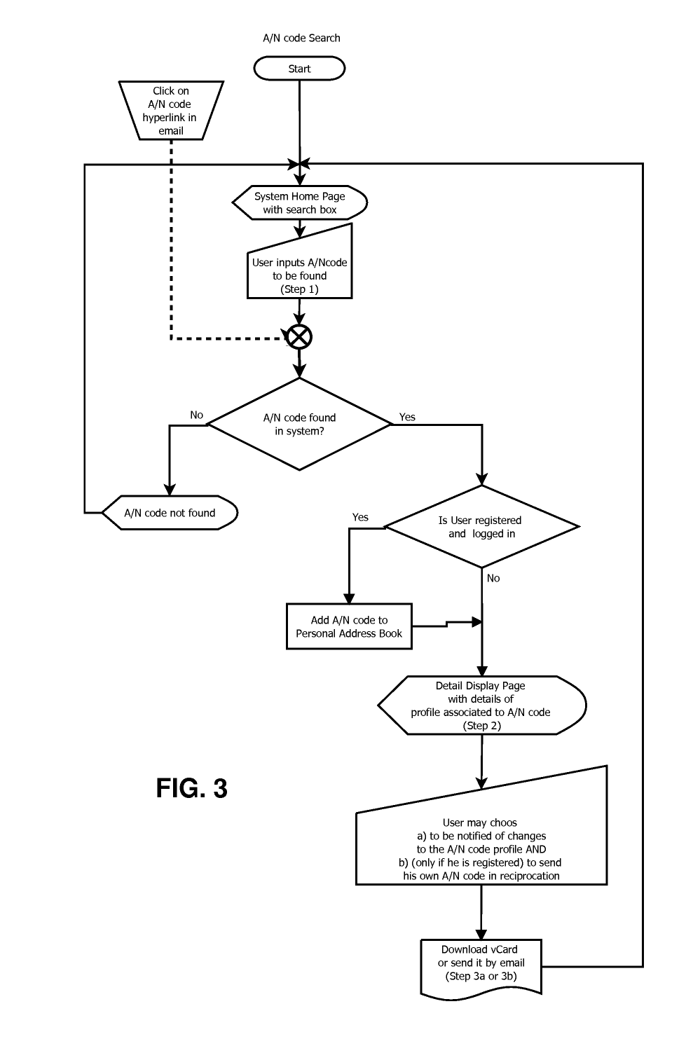

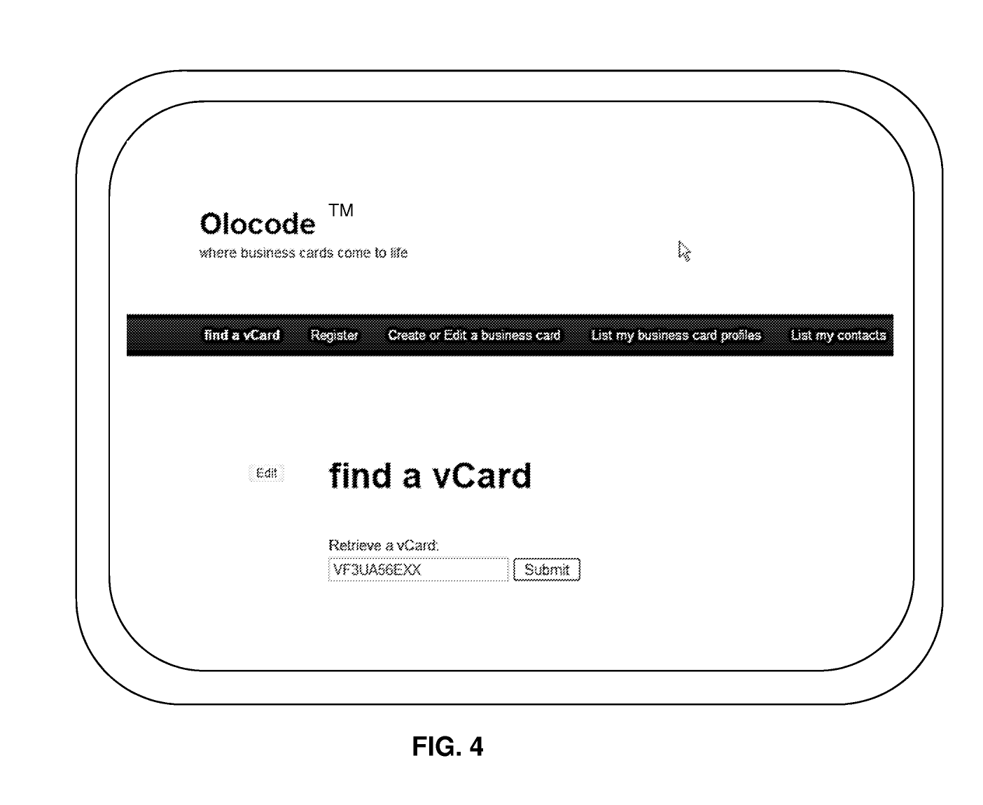

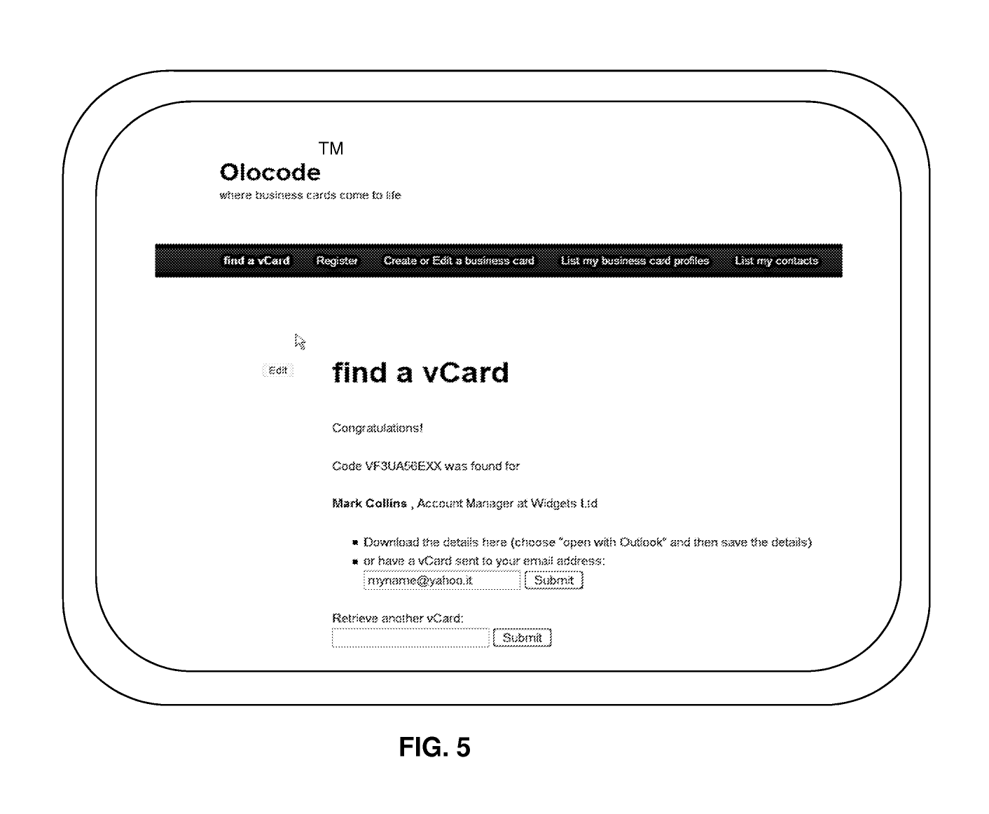

An embodiment of a method for retrieving an A/N code is shown in FIG. 3. If the receiver (B) of A's business card or email wants to retrieve A's profile details and store them for later recovery (e.g., on a mobile device), he will go to the system website and type the A/N code string into the search box. A representative screen shot for this step is shown in FIG. 4. The system then checks if A's A/N code is registered and active, and if so it displays a page with A's profile details for that specific A/N code (the details display page, or DDP). A representative screen shot for this step is shown in FIG. 5. Alternatively, if B has received an electronic message, for example an email, with a hyperlink to the A/N code DDP, B will only need to click on the hyperlink and see the DDP corresponding to the A/N code in its browser (dashed line of FIG. 3).

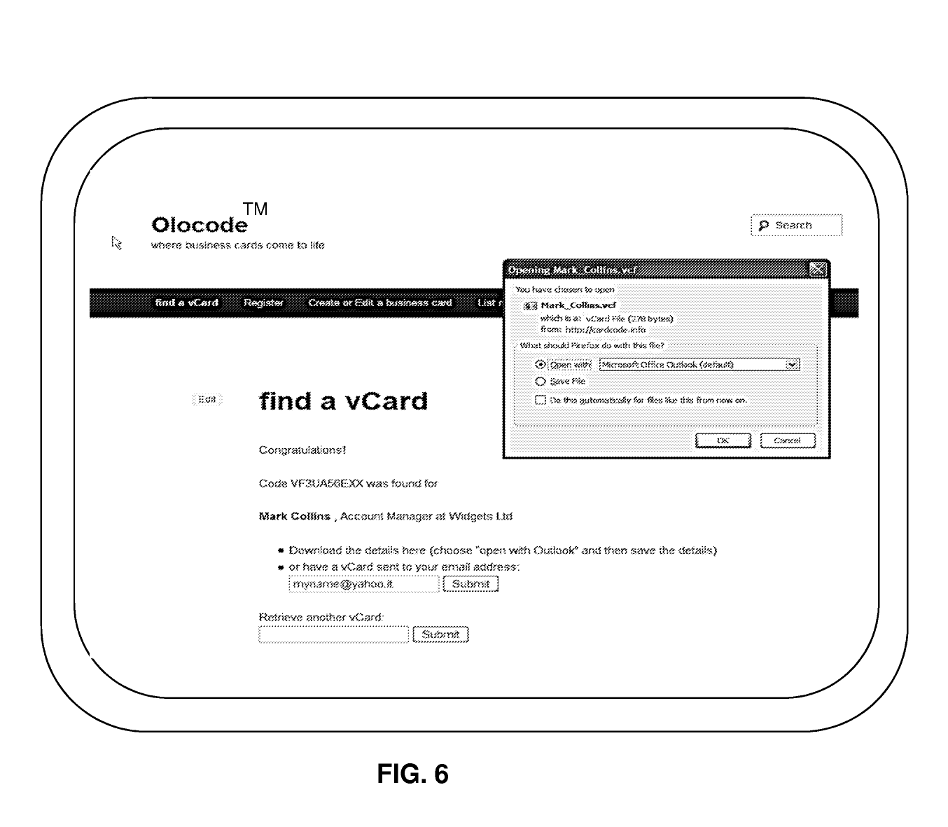

From the details display page (DDP), the system allows B to download such contact information in the form of a vCard (as a file with a .vcf extension which will then be recognized by most operating systems in a personal computer or smart mobile phone) or to send an email to an address provided by B, with attached a vCard and in the body a text representation of the contact details. The vCard can be in a unique or a common format, such as a format listed in Internet Engineering Task Force RFC6350, available at http://tools.ietf.org/html/rfc6350, incorporated by reference herein in its entirety. The RFC6350 protocols may also be described as “vCard 4.0.” A representative screen shot for this step is shown in FIG. 6. The vCard will also contain a hyperlink to the DDP, in accordance with the definition of the UID field of the vCard specifications. In this way, B has a way to always recover an updated version of A's contact details.

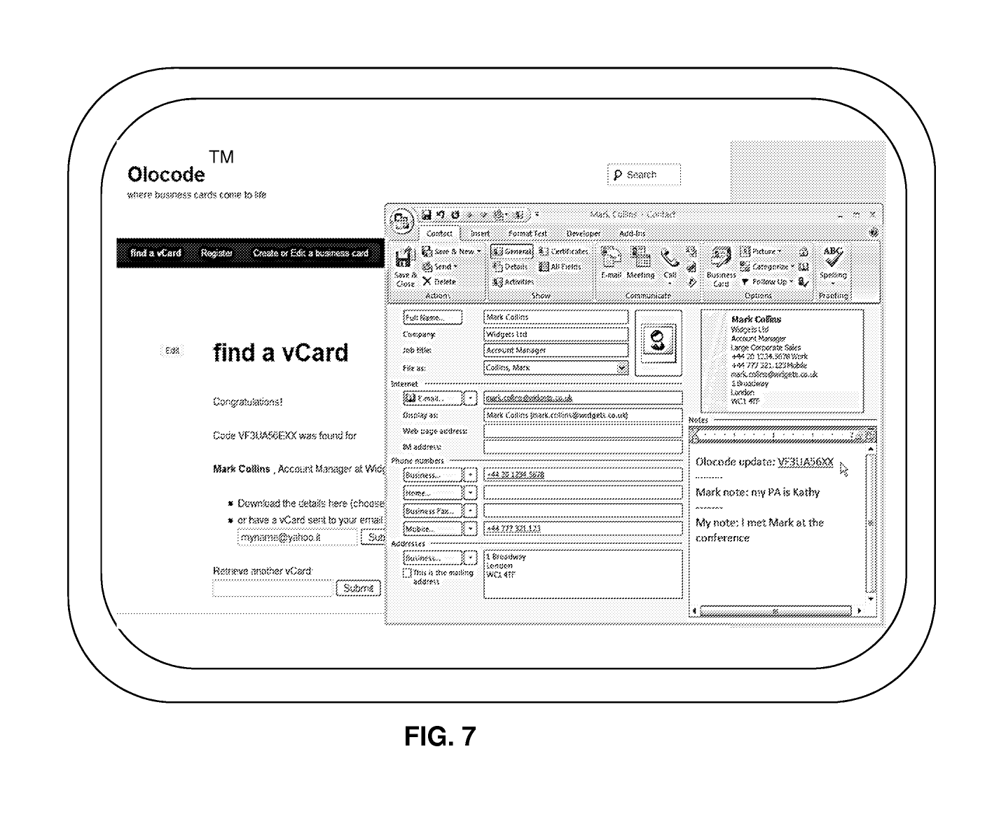

The vCard may also contain a timestamp to indicate when the A/N code was first retrieved (to remember when the person was met) and last updated by its owner (to alert of any changes). The vCard will also contain any notes that B has added in his PAB regarding this A/N code. See FIG. 7. To the extent possible, fields that are not covered by the vCard standard or that common vCard readers (such as Microsoft Outlook) do not interpret correctly will be added to the vCard Notes field.

In the embodiment shown in FIG. 3, B, seeking to obtain A's information using A's A/N code, is registered with the system and given the opportunity to automatically receive updates if A's information changes. B is also given the opportunity to create his own A/N code, thereby allowing B to distribute his contact information using his unique A/N code and/or to send his new A/N code to A in reciprocation.

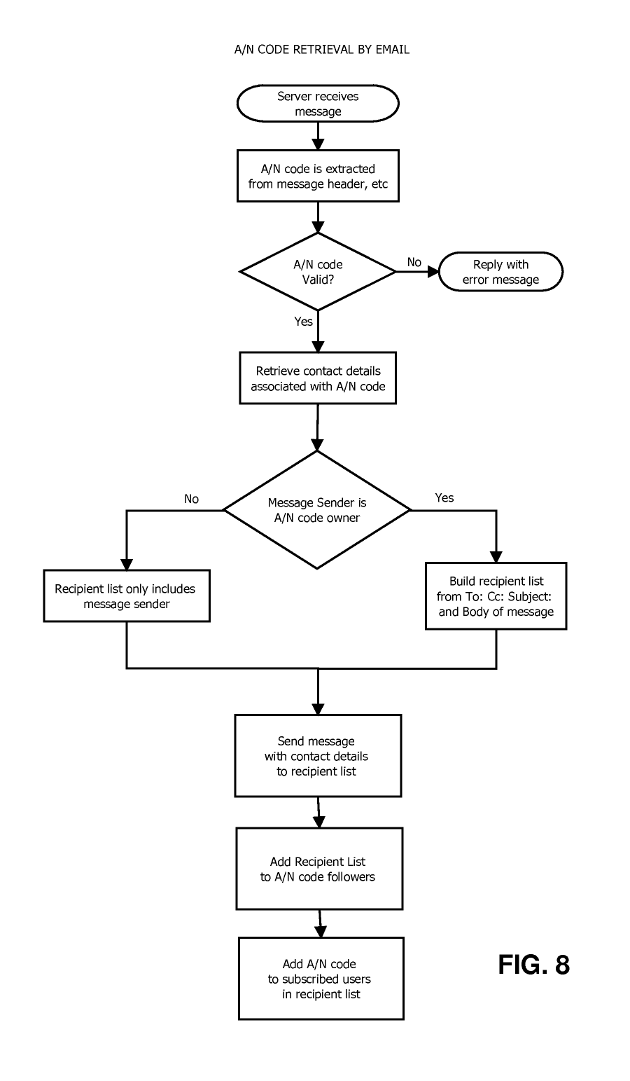

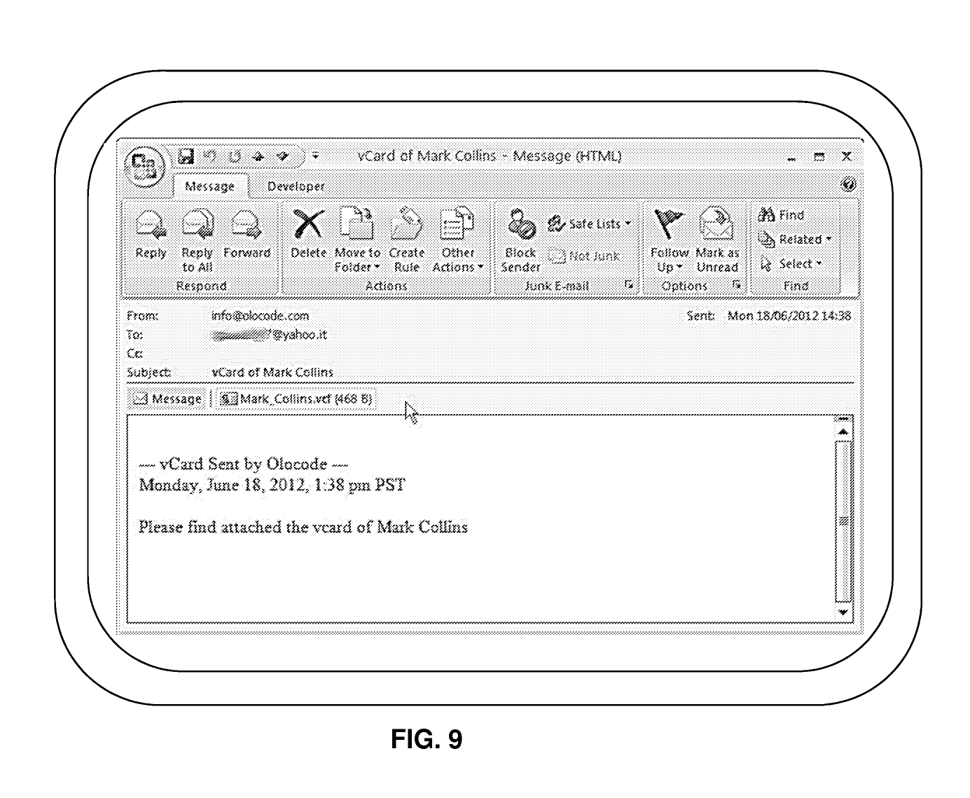

FIG. 8 details an alternative approach for B to retrieve the contact details associated with A's A/N code. The method of FIG. 8 may be referred to as Code E-mail Registry or CER. In FIG. 8, B sends an email message from an email account that he controls to an e-mail address equal to, or associated with, A's unique A/N code at a specifically designed server, which will return A's contact details through a response email to B, such as illustrated in FIG. 9. The same principle can be used for A to “push” the contact details associated with his A/N code to a group of people through their email address. The server behaviour will vary depending if the email message to the server is sent by A, himself, (allowing for contact details to be sent to a plurality of email addresses) or by another person (in which case contact details are only sent to that person). This approach minimizes the time and effort required to retrieve contact details by removing the need to load on a browser the internet page containing the request form from the server, and the need to type the user email address (which is instead automatically provided by the “from” header of the email address). Instead, with this approach it is sufficient for the user (B) to send an email message to <A/N codeID>@<server>.

Alternative CER formats are possible where A's A/N code is either part of the email address, part of the email subject, or part of the email body, for example, if a portion of text of A's A/N code is common to other A/N codes relating to the same organization, such as <common prefix>-<unique suffix>, an alternative format could be <unique suffix>@<common prefix>.<server>, or <unique suffix>@<organization server>.

Upon receiving the appropriate e-mail code, e.g., <A's A/N code>@<server>, the server processes the email and identifies that the email local part is a validly formatted A/N code. The server then searches the A/N code database and retrieves the associated contact information. The server next verifies that the sender's email address is one of A's registered email addresses in the system. If it is, i.e., email is coming from A, Server collects all other email addresses in the cc: or bcc: fields and then e-mails all of these addresses along with the headers of the email, as well as any other valid email address that can be parsed in the subject line or in the body part of the email message. An email containing contact information associated with A's A/N code is then sent to all those email addresses.

In the event that the e-mail did not originate from one of A's registered e-mail addresses, i.e., email is not coming from A, the server sends a reply email only to the sender's email address containing contact information associated with A's A/N code. The system may also add the recipient of each such email to the list of followers of A's A/N code (optional feature for A to choose). The system checks if any such email address is also a registered address in the system, in which case A's A/N code is added to the corresponding user's Personal Address Book (PAB).

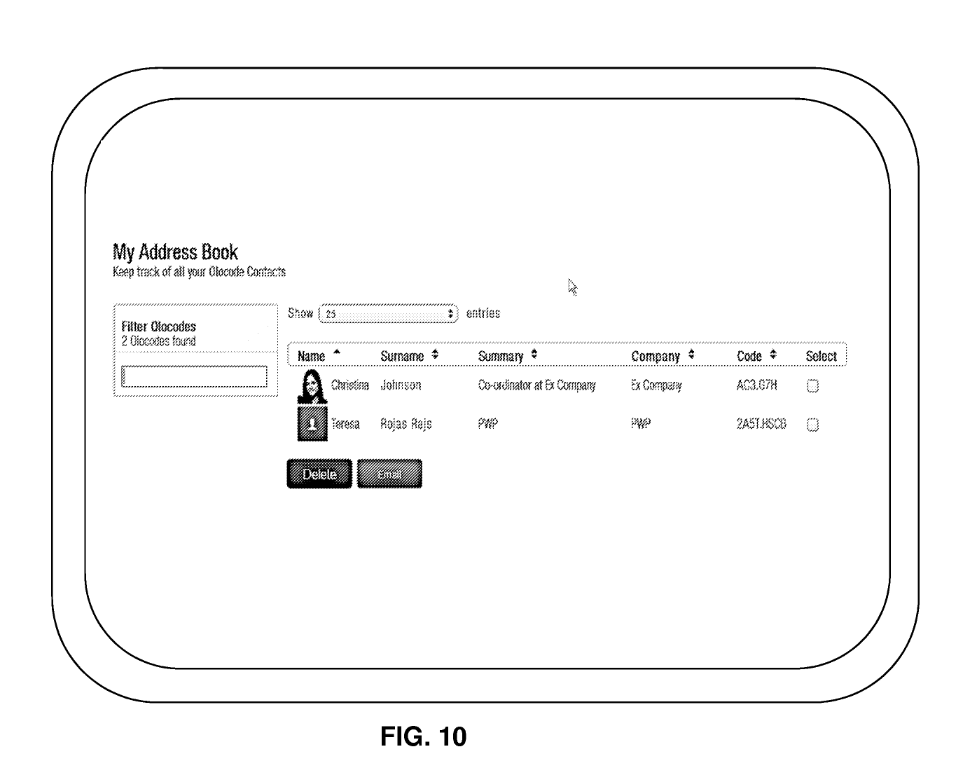

The Personal Address Book (PAB) allows browsing through a user's own retrieved A/N codes and is a way to retrieve the most updated version of each saved A/N code profile. An exemplary PAB is shown in FIG. 10. The user can decide to remove an A/N code from his PAB. The user can filter through recently updated A/N codes, which also appear in a different color until they have been checked by the user. A user can also import contacts from other contact management systems into the PAB. Duplicate contacts that refer to the same A/N code can be treated as duplicates, as well as contacts that have identical information in all fields. The user may be prompted to delete a contact having the same name fields as another contact, but not having an A/N code. Several techniques can be used to treat partial matches, either by maintaining two separate records or by suggesting a merged version of the two.

If B is a registered user on the system, whenever B retrieves a new A/N code the A/N code is also added to his Personal Address Book (PAB) managed by the system. The system can recognize B either because he provides his username and password in an input form or, if B is using the CER approach, because his email address (as found in the From message header) is recognized as one of B's registered email addresses in his account on the system.

If B is a registered user, he can choose to be notified if an A/N code is updated, by receiving a notification email with or without an updated vCard attached to it. B then becomes a “follower” of A through that A/N code. Even if he is not registered, B could still be a follower of A by providing his email address. Typically, A is able to see the list of followers for each of his A/N codes, and delete those followers that he does not like. The PAB also allows B to add personal comments on the A/N code, such as why it is important to stay in touch with A.

If B is a registered user, he can additionally choose to send his own A/N code to A. Two possible alternative paths can be followed. In the first, A will be notified by email and will see B's A/N code in A's PAB, waiting for approval. A may decide to keep B's A/N code in his PAB, or delete it. In the second, A could have chosen to enact “autopairing,” by which the system automatically allows B's A/N code to be added to A's PAB without the need of A's explicit approval if A's A/N code is already in B's PAB (which indicates that B has presumably made contact with A previously).

### A/N Code Aliases

An A/N code (Code1) can be indicated to be an alias for another A/N code (CODE2). Users trying to retrieve CODE1 are treated as having retrieved CODE2, with a warning message that CODE1 is an alias of CODE2. Both CODE1 and CODE2 must be associated to the same user. This is for example helpful when a person uses CODE1 and is then provided with a Corporate A/N code (see below), i.e., CODE2. By making CODE1 an alias of CODE2, people who had been given the old A/N code can still trace this user without him having to maintain two identical profiles. At any time, the user can remove the “alias” association between CODE1 and CODE2 and regain full control of CODE1. If CODE2 is deleted or is no longer associated with the user, the alias relation automatically disappears.

Notably, A/N Code aliases are different from an A/N code forwarding (see below) in that aliases do not point to a different user.

### Code Groups

A code group is a collection of A/N codes identified by a different, unique A/N code. Code groups are useful to constantly keep up to date working party lists, project teams, etc. Members of the code group should be all registered users of the system with their own A/N code, though in a version of the invention code group members may be indicated via their email alone (but with restricted functionalities). Members of the code group also automatically exchange their A/N codes and so each of them can see the details of all other party members (via the shared A/N code).

Code groups have their own unique ID that correlates with a list of member A/N codes. The code group may have an email address such as <code_groupID>@A/N code.com. Messages sent to this address are forwarded to all members of the Code group. The code group typically has a manager, which is typically the creator of the group. The manager typically also has control over what content (if any) group members are allowed to edit. Finally, a code group will also typically have a group display format that lists all the summary information for all members of the group and allows each member to see details of each other.

Typically, a code group is administered by a manager who can, among other things, create the code group and assigns it a unique ID as well as destroys the code group. Typically, destroy functions do not delete newly formed relationships among members. The manager can also add members by adding an A/N code to the members list. This method can be invoked by the manager and, in one possible version, may also require approval from the member via an email or through the system. The manager can also delete members or the members can delete themselves from the code group. The manager can set sharing levels for the members of the code group such that content is automatically shared among all of the A/N codes of all members. In one possible version of the invention, this step may require individual approval from each member before being executed to prevent spamming. The manager also has the ability to perform standard tasks such as displaying a structured representation of the member list (for example in XML language) and that allows the system or other software to retrieve each A/N code details so as to produce a formatted list of all group members.

### Corporate Code Accounts

Large organizations may decide to manage A/N codes on behalf of their employees. Such organizations may want to use a common prefix to each such A/N code, such as MYCOMPANY. In this way, people are always aware that such A/N code corresponds to a company employee. A register of prefixes and associated corporate entities could be provided to all system users.

A corporate account can be associated to one or more internet (sub)domain names. Following such association, no other system user can register an A/N code with an email address which is part of such registered (sub)domains without the consent of a Corporate Administrator. Corporate accounts have an associated list of employees, divided between one or more administrators, Personal Assistants (PA) and “simple” employees. PAs perform a number of activities for a group of employees according to the permissions granted to them by a Corporate Administrator.

Permissions for the various roles will be based in accordance to Table 1. Permissions marked with an asterisk depend on the choice of an Administrator

TABLE 1
Exemplary Permission Table for Corporate Code Account.

| | | Corporate A/N | |
|---|---|---|---|
| Role | User Accounts | codes | Corporate features |
| Adminis- | Create | Create, Retrieve, | Can choose corpo- |
| trator | | Edit, Delete | rate prefix, can |
| | | | choose corporate |
| | | | (sub)domains, can |
| | | | create/import |
| | | | corporate users, |
| | | | can assign roles to |
| | | | users, can associ- |
| | | | ate employees to |
| | | | PAs |
| Personal | Create* (limited | Create*, Edit*, | |
| Assistant | to employees attri- | Delete* limited to | |
| (PA) | buted to this PA) | employees attri- | |
| | | buted to this PA. | |
| | | Retrieve any A/N | |
| | | code. | |
| Employee | Create, Read, Edit, | Create*, Edit*, | |
| | Delete (limited to | Delete* limited to | |
| | his own user ac- | the Corporate | |
| | count) | A/N code attri- | |
| | | buted to him. Re- | |
| | | trieve any A/N | |
| | | code | |

Administrators and PAs can create user accounts on the system for their employees. This is necessary because an A/N code always needs to be associated to a user account so when creating a corporate A/N code a user account is created for the employee. The employee is informed of this new account assigned to him and, if he already has a user account with the system, he can choose to delete the newly created account and assign the Corporate A/N code to his previously created account. The Corporate Administrator and PA retain the same privileges over the Corporate A/N code regardless of which user account it is assigned to.

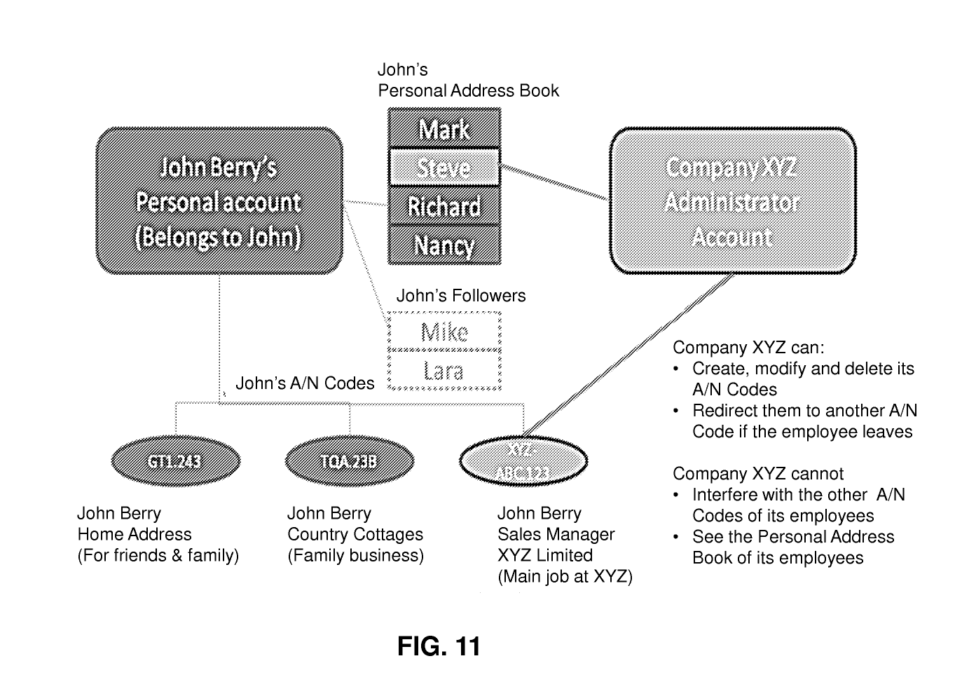

The relationships between personal and corporate A/N codes are illustrated in FIG. 11. Administrators and PAs cannot however read or modify the data in such user accounts nor see the PAB of such accounts. This is to protect the privacy of the employee and increase trust in the A/N code system. A company however has some rights over Corporate A/N codes that have been distributed and it is not outright clear if someone “following” the Corporate A/N code of an employee is only interested in the company, in the employee or in both. Therefore, the Corporate Administrator or PA can “blind push” the A/N code of another employee to the followers of a departed employee, even if they cannot see who they are. In this way, privacy of the departed employee is protected, but a service is provided to the follower informing him of the new contact person at the firm.

### A/N Code Forwarding

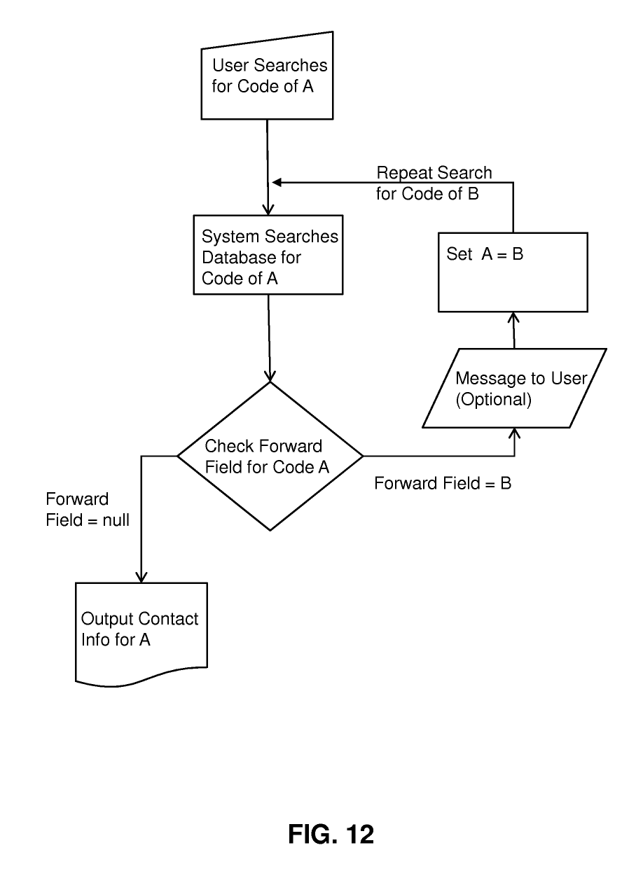

When employee C leaves the organization which had given him a Corporate A/N code, the A/N code administrator (A) may be faced with the choice of either replacing the original data with the data of a new employee (D), or keeping the original profile details of C but forwarding any request to retrieve C's A/N code towards D. In this case, the retrieving user, B, who may be a client of C's employer, and is looking for C's contact, is informed that C is no longer part of the organization and that any request may now be dealt with by D. The system thus registers next to each A/N code if it is to be forwarded, and the new A/N code to which a request needs to be forwarded. A flow chart illustrating this process is shown in FIG. 12. Of course, this function will also be useful in the event that C experiences some other change in job status. For example, C may receive a promotion, be transferred to a different location, take maternity (paternity) leave, etc.

The personal relation between B and C as individuals (regardless of their A/N codes) is established when B retrieves the A/N code of C, and should not be destroyed unless explicitly requested by either B or C. Also, B might have chosen to “follow” changes to C contact details and so expects to be informed. For this reason, if B had received an A/N code containing C's contact details (whether such A/N code was owned by C or by C's employer) and B decided to become a follower of C then a new record containing a unique identification of B (which may be his user ID in the system or his email address if he is not registered), the user ID of C and C's A/N code linking B and C should be added to an internal relationship table in the System, not visible to users. Upon deletion or forwarding of the linking A/N code, the record is not destroyed but the linking A/N code field is set to NULL.

Additionally, even when the linking A/N code field is set to NULL, B should always be able to send a message (either free text or one of a standard set of messages provided by the system such as “keep in touch”, “I have a business proposal for you”, etc.) to C. See FIG. 12. B will not see C's email or other contact details because there is no A/N code linking the two of them, and B's message will be delivered by the System to C. C will be able to respond to B and provide him with his new whereabouts if he so wishes. If B was also a “follower” of C, B will receive a notification of C's departure, such as “We would like to inform you that C's role at [the organization] is now being covered by D. [Optionally provide D's A/N Code] C will be able to separately send you his new contact details but we thought you might like to know how to get in touch with [the organization] going forward.”

In some instances, the contact information associated with C's Corporate A/N code will be re-associated with D's contact information. The new contact information, i.e., D's contact information, may be automatically provided to B, for example, through an electronic message, “We would like to inform you that C is no longer with [Firm] and that A/N code CORP-XYZ123 is no longer valid. Mr. D is the new person in charge of C's role. Would you like to receive D's details?” If B chooses “yes,” for example by selecting a hyperlink in the message, a new vCard (for example) containing D's details would be added to B's PAB, downloaded to B's desktop or address book on B's phone. C should always be able to “push” its new A/N code to B, which will appear as a notification from the System. B is however free to accept such new A/N code in his PAB or disregard it. Of course, B or C can both independently decide to terminate the link between them. From that moment the two parties will be unrelated.

Depending upon the settings for the corporate code account, upon leaving the organization, C will lose access to any corporate A/N code owned by his old employer (as per determinations of Administrator A) but he will not lose access to any of the A/N codes he collected in his PAB: the PAB is a characteristic of the user account and is only visible to that user. After an adequate period of time (e.g. some months) the Corporate Administrator may decide to delete C's corporate A/N code. The forwarding is then terminated and anyone looking for that A/N code will be notified that it no longer exists.

Additional embodiments of the invention may include a computer system for managing contact information, comprising a processor and storage. The storage contains instructions that, when executed by the processor, cause the computer system to receive a first unique alphanumeric code from a user over a communication network, access a database to identify first contact information associated with the first unique alphanumeric code, provide the first contact information to the user over the communication network, receive instructions to associate a second unique alphanumeric code with the first unique alphanumeric code, and provide the second unique alphanumeric code and second contact information associated with the second unique alphanumeric code to the user over the communication network.

The computer system storage may additionally contain instructions that cause the computer system to compare the first unique alphanumeric code to a plurality of unique alphanumeric codes stored in the database. The computer system storage may additionally contain instructions that cause the computer system to provide the first contact information cause the computer system to send an electronic message with the first contact information to the user over the communication network. The computer system storage may additionally contain instructions that cause the computer system to provide the second unique alphanumeric code and the second contact information cause the computer system to send an electronic message with the second unique alphanumeric code and the second contact information to the user over the communication network. The computer system storage may additionally contain instructions that cause the computer system to output automatically the second unique alphanumeric code and the second contact information to the user after instructions to associate the second unique alphanumeric code with the first unique alphanumeric code are received.

The computer system may communicate with a computer or a mobile device over the communication network, i.e., when a user is using and located with the computer or the mobile device. The computer system may comprise a web browser while the storage comprises instructions to receive a unique alphanumeric code from the web browser. The mobile device may comprise an application while the storage comprises instructions to receive a unique alphanumeric code from the application. The computer system may also communicate with a computer or a mobile device over the communication network, i.e., when an administrator is using and located with the computer or the mobile device. In such instances, the computer system may comprise a web browser while the storage may comprise instructions to receive instructions to associate a second unique alphanumeric code with the first unique alphanumeric code from the web browser. Additionally, the mobile device may comprise an application while the storage comprises instructions to receive instructions to associate a second unique alphanumeric code with the first unique alphanumeric code from the application.

In all of the above examples, the first and second unique alphanumeric codes may relate to employees of an employer. Additionally, the user may receive goods or services from the employer. In such instances, the first unique alphanumeric code may be for a first employee, and the second unique alphanumeric code may be for a second employee that has assumed duties of the first employee. The storage may additionally contain instructions that cause the processor to provide to the user over the communication network a notice of a change in status of the first employee. For example, the change in status may comprise a change in job title, a change in job territory, a change in office address, a change in job duties, a change in employer, or a change in employment status.

In all of the examples above, the first and/or second alphanumeric codes may each comprise a sequence of four to twenty symbols drawn from upper case Latin letters, lower case Latin letters, and Arabic numerals. In some instances, at least a portion of the alphanumeric code is specific to an organization. In such instances, all members belonging to an organization may have at least a portion of the alphanumeric code that is identical. For example, the portion of the alphanumeric code specific to the organization may be separated by a special character (e.g., a dash or hyphen).

The invention additionally includes a method of distributing contact information, comprising receiving a unique alphanumeric code from a user over a communication network in the form of an electronic message, extrapolating the unique alphanumeric code from the message, identifying the sender address and format through the information contained in or associated with the message, accessing a database to identify contact information associated with the unique alphanumeric code (wherein if the sender address is one of a list of addresses associated in the system with the individual identified by the unique alphanumeric code, building a list of all other recipient addresses contained in the message), and providing the contact information to the user and/or to any other recipient in the list over the communication network in the form of another message.

In the above instance, the received electronic message may be in the form of electronic mail and the unique alphanumeric code may be programmatically derived from the headers and the body of the electronic mail message. For example, the unique alphanumeric code may be the local part of the email address [e.g. abc123@server.com]. In other instances, the unique alphanumeric code may comprise a string that is unique for a specific organization and common for some or all of its members, and/or another string portion which is unique to a specific individual [e.g. bigcompany-abc123]. The string portion unique to the individual may be placed in the local part of the email address and where the organization-specific string is univocally mapped to the domain part or to a subdomain of the domain part of the email address [e.g. abc123@bigcomp.server.com or abc123@vcard.server.com or abc123@vcard.bigcomp.com].

In some instances, the unique alphanumeric code may located in the subject header or in the message body of the email. The response message may be in the form of an email. The response email may contain the contact information as an attachment in the form of a vCard. The response email may contain the contact information as plain text in the message body of the email. The response email may contain the contact information as a Uniform Resource Identifier that directly or indirectly points to such contact information. In the above examples, the recipient addresses may be located in any of the TO, CC, BCC, and Subject headers of an email message, or in the email body. Additionally, either the received or the response electronic message may be sent using a Short Messaging Service, a Multimedia Messaging Service or an Instant Messaging service. The response may alternatively contain the contact information either as plain text, as an attached file or as a Uniform Resource Identifier that directly or indirectly points to such contact information. In some embodiments, the system verifies that the user is registered in the system and associates the user with the contact information in the system [i.e. no vCard is sent but the contact information can later be retrieved by the user on his Personal Address Book].

### Secure Website Login Via E-Mail

Additionally disclosed herein are methods and systems to facilitate secure logins, e.g., using a mobile device. The method allows a user to avoid having to type in a user name and password when interacting with a website on a mobile device. Instead, the user simply sends an auto-generated message to a server associated with the website, whereupon the server verifies the message address and the device identity and sends a return message to the user with a hyperlink to the logged-in website. The user merely activates the hyperlink in the message and then continues using the website as if the user had logged-in properly. The messages can be sent and received via, e.g., e-mail, text, or instant messaging.

Most websites require a login/password combination to grant full access to their registered users and will have stored and verified the user email address upon registration. The login is either a username or the same email address used at registration. The password is a user-specified combination of letters, numbers and special characters that may need to fulfill a number of criteria specified by the website to reduce the risk of being easily guessed. If a user forgets their password, most websites are available to send a password reminder by email, upon verification that the email entered corresponds to a registered user, implicitly acknowledging that whoever has access to an email inbox is its legitimate owner. Some systems do require one or further authentication steps which may include answering to a secret question.

Some systems will send a password reset hyperlink inside the email. The hyperlink contains reference to a unique ID associated with the user and that may expire after a specified amount of time. Clicking on the link requires the user to enter a new password, after which the hyperlink becomes inactive. The result of a password reset is that while access is granted to whomever has access to the email, if the email had been intercepted by a third party and a new password was entered the legitimate user would be made aware of this upon their next login, as the original login/password combination would no longer be valid.

Since access to the mailbox can be considered a sufficient identification form, past inventions have addressed the possibility of user authentication via an exchange of email messages with an authentication server, though such inventions typically require the authentication server URL and the communication protocol and parameters to be known to the client device. In the present invention, the user and the client device are not required to know anything about the authentication server, and all the necessary information to be authenticated is provided to the client device by the application server.

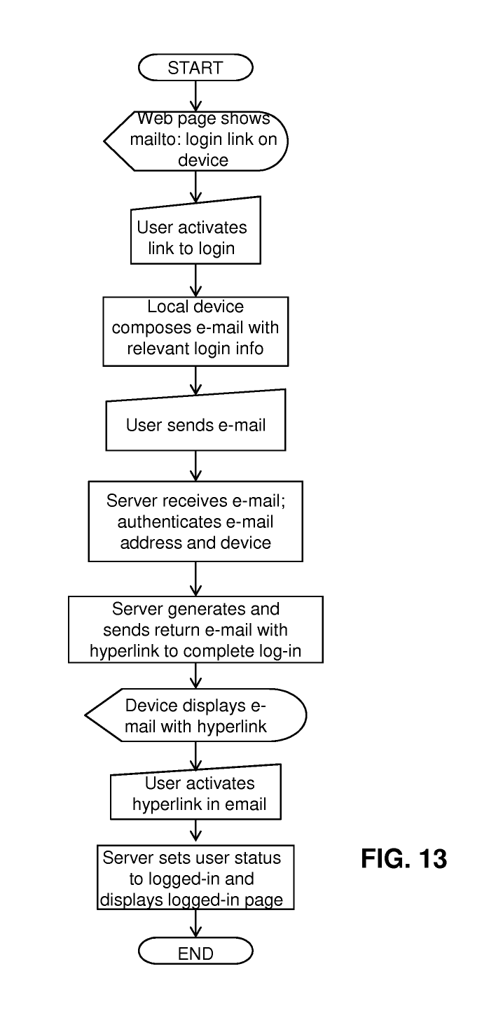

These problems are overcome by the disclosed systems and methods whereby secure a login can be achieved an equivalent level of security to a traditional login via username/password. A flowchart describing the message login method is shown in FIG. 13.

In one embodiment, the method begins when a user sends HTTP request to the home/login page of a website and the application server provides it including a “Login by email” button. The button is a mailto: hyperlink such as mailto:login@authserver.com?subject=sessionID123456+IP012.212.133.255 where sessionID is automatically generated by the web server so as to provide a specific time frame for the login, and IP contains the IP of the mobile device when the request was generated. Additional information could include the ID of the application server if the authentication server was a shared service for a number of application providers. At this point, the user wishing to be logged in on the application server website clicks on the button. (First click) This action automatically moves focus (on the user device) to the default email client and pre-fills an email message to the authentication server which automatically contains the session ID, client device IP and application server ID as the subject. The user sends the message with no additional typing (Second click).

Upon receiving the e-mail message, the authentication server determines 1) the user email address in the FROM header and 2) the sessionID, client device IP and possibly application server ID in the SUBJECT header. The authentication server then checks if the sender email address is associated to an already registered user on the application server and if the session ID is still valid (e.g. not too much time has passed from the request). This check could also be postponed. If the check above is positive, the server sends a response email message to the user with a unique hyperlink to a URL in the body of the message.

Once the user has received the return e-mail, the user opens the email message (Third click) and clicks on the link (Fourth click). The device's focus is now passed back to the user browser that sends an HTTP request to retrieve the hyperlink. At this point, the application server verifies that user email address is indeed registered (if this had not been done before in step 5) and maybe also that IP is the same as the one that generated the original request. If so, it responds to the HTTP request by displaying the website in the “logged in” status for the user.

For additional levels of security, the server could ask, after login, to answer a simple question (e.g. what is your favorite drink between water, soda, champagne, etc.). If the user answer is different from the past, the system would permanently record it and it would notify the user that this is not their usual choice, and when it was last changed. This would allow a user to find out if someone has accessed the website with their email; the chance of getting the correct answer for an intruder would be small.

The disclosed message login methods offer several advantages. For example, there is no need to type anything to log into a website. That is, in 4 clicks (login button, send email, open response email, follow link in response email) the user can be into a secure website environment. This process generally takes only a few seconds with push email. The system does not sacrifice security compared to traditional login/password method. The password is not disclosed in the email. The log-in system may also provide a simple method to track login history for users, by providing a page of “e-mail login history.” Additionally, if desired, the system may easily be combined with a two-factor authentication system like an RSA key.

In some embodiments, the system can easily be redesigned as a SaaS whereby the user email traffic is with a 3^{rd} party server which verifies login credentials and then sends an authentication message to the original server without having to disclose those credentials. This may be helpful in payment systems or for websites that offer unified sign on to third parties, e.g., social media websites. Furthermore, if a standard evolves in the format of authentication messages, the email client could filter messages that conform to the standard to avoid cluttering the email box of the user with login messages. Also, the web browser on the client device might be allowed to send authentication messages through the email client and receive authentication responses without user intervention. At the moment, largely for security reasons and to protect the anonymity of internet users, internet browsers are not capable of interacting with the email client without user intervention. To overcome this limitation would require that authentication servers receive a “trusted” status from some recognized certification authority.

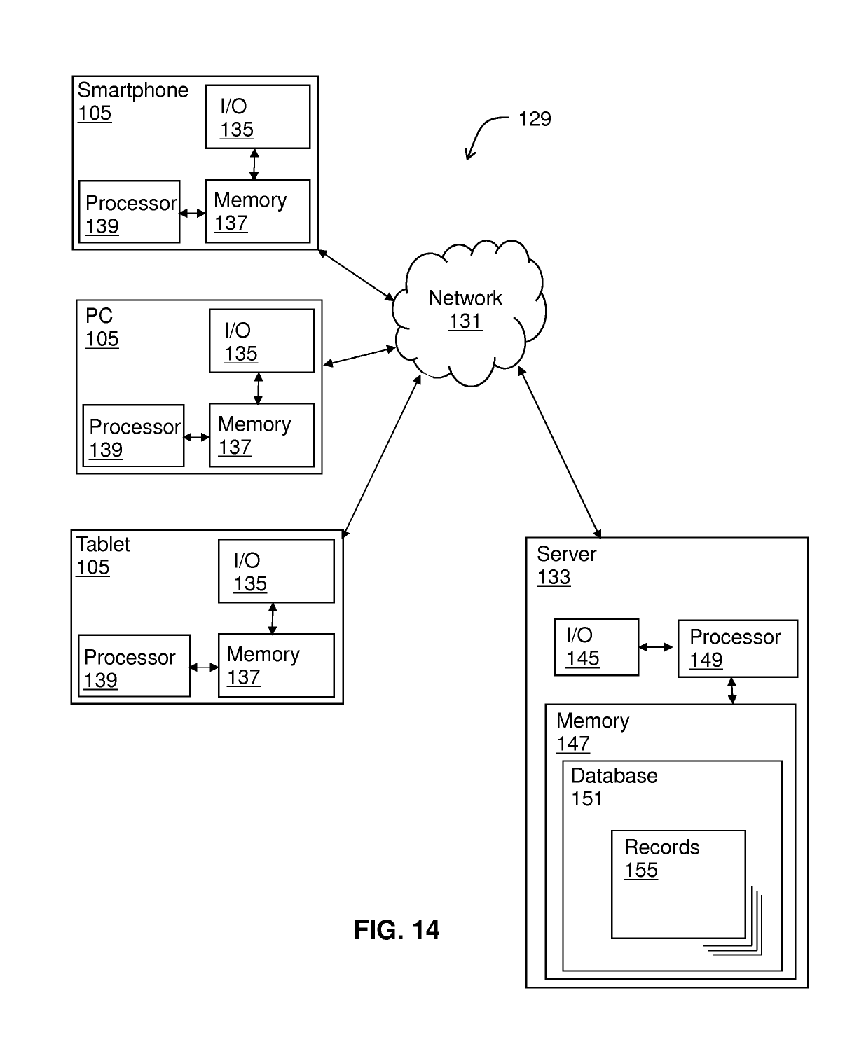

An embodiment of a system for executing the e-mail login method described above is shown in FIG. 14. FIG. 14 illustrates the use of device 105 to obtain data from a server 133 via network 131 and to send data to the server 133, e.g., in the form of an e-mail. Here, device 105 may include provisions for accessing an app store, for downloading an app, for accessing the internet with a web browser, for accessing e-mail, and for performing methods of the invention (e.g., as depicted in FIG. 13), or combinations thereof.

As shown in FIG. 14, device 105 may be a smartphone, PC, tablet, or any other suitable device. Device 105 will generally include a memory 137 coupled to a processor 139 as well as an input/output mechanism 135. Server 321 may include one or more computer devices using one or more of processor 149 coupled to memory 147 as well as input/output device 145. Memory 137 or may be taken to include one or more of a volatile or persistent memory such as RAM or storage. Computer storage can be provided by a hard drive (e.g., magnetic disk drive), flash memory, solid state drive (SSD), removable compact flash card, or similar. Processor 139 or 149 will generally include one or more computer processor such as a microchip made by Intel. Input/output 135 or 145 may include a mouse, keyboard, monitor, screen, touchscreen, network interface card, Wi-Fi card, cellular modem, Ethernet jack, USB jack, radio-frequency identification transponder, similar, or combinations thereof. Device 105 may be in communication with server 133 via network 131. Network 131 may include one or more of a wireless or wired internet communication device (e.g., router, hub, or switch), cellular tower, modem, land lines, satellites, antennae, similar structures, or a combinations thereof. Server 321 may house a database 151 that includes records 155 wherein may be stored any of the information described or required herein. Any such information may additionally or alternatively be stored in memory 137. Preferably, memory 137 or memory 147 is a tangible, non-transitory device that may contain the instructions executable to cause a system or device of the method to perform any of the steps, methods, or functions described herein.

Using the systems described above, it is possible to authenticate a pre-registered user on an application server from a client device. The process typically comprises initiating a data exchange with an application server on an unverified messaging service, such as the user loading the homepage of a website in a browser. Upon initiating the data exchange, an authentication request message is sent by the client device using information provided by the application server to an authentication server via a verified messaging service and comprising a number of additional elements for identification. For example, a user may click on a button containing a MAIL TO: hyperlink and that generates a new e-mail message that is sent by the user. The authentication server, in turn, responds to the client device by providing, for example, an e-mail message with an authentication mailbox address using the verified messaging service and also sending the same mailbox address to the application server using a trusted communication channel. At this point, the user needs to merely initiate the hyperlink in the return e-mail, and the user is logged in.

The unverified messaging system may use SMTP, SMS, MMS, IM, XMPP, web service, SOAP, XML, WAP, WML, HTTPS, or HTTP. The message itself may be encrypted or not. In some instances, the client device will be capable of communicating on both the verified and the unverified messaging services. In some instances, the client device stores the authentication details for the verified text messaging service such that authentication can be completed without user input.

The methods of secure log-in can be achieved in a variety of ways. For example, a user can authenticate by using a selectable element displayed by the client device and generated in HTML, such as an A tag with an HREF attribute whose URL value uses the mailto: scheme. By way of example, <A HREF=“mailto:login@proxyserver.com?subject=abc123456”> Login by email</A>.

Alternatively, a user can be authenticated in another sensorial representation (text, picture, audio, video, tactile feedback), and the response may be collected by the client device through any human device interface. In such instances, the automated authentication request message can be created by the local device using any available verified text messaging service. Furthermore, the secure identification elements may comprise a timestamp, a URL or similar identifier for the application server, a session identifier, and the IP, MAC Address or other unique identifier of the client device.

As an extra security measure, the device, e.g., using the security application on the device, can verify that the authentication server is valid before sending the authentication request message to the authentication server. The authentication server may comprise, for example, an exclusive authentication mailbox address that is only used to send and receive validation request and return validation messages. In other embodiments, additional security can be added by using a synchronized rolling address code that becomes part of the login request message or the return login message. Alternatively, or in addition, the authentication mailbox address may contain some or all of the additional elements in the authentication request message.

Using the method above, the application server will typically compare the now authenticated user against its database of registered users and their corresponding verified text messaging addresses, and processes further user requests accordingly. In some instances, before granting authentication status to a user pretending to be registered, the application server can issue challenges, i.e., requesting the user to supply additional information. The challenge may be in the form of a question and the server may store and display the replies for use in future login sessions with the user.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention. Consequently, the invention is intended to be limited only by the scope of the appended claims, giving full cognizance to equivalents in all respects.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

1. A method of distributing contact information, comprising:
receiving a first unique alphanumeric code from a user over a communication network;
accessing a database to identify first contact information associated with the first unique alphanumeric code;
providing the first contact information to the user over the communication network;
receiving instructions to associate the first unique alphanumeric code with a second unique alphanumeric code; and
providing the second alphanumeric code and second contact information associated with the second alphanumeric code to the user over the communication network.

2. The method of claim 1 wherein receiving the first unique alphanumeric code comprises communicating with a computer or a mobile device over the communication network, the user using and located with the computer or the mobile device.

3. The method of claim 1 wherein accessing comprises comparing the first unique alphanumeric code to a plurality of unique alphanumeric codes stored in the database.

4. The method of claim 1 wherein providing first contact information comprises sending an electronic message with the first contact information to the user over the communication network.

5. The method of claim 1 wherein receiving instructions to associate the first unique alphanumeric code with a second unique alphanumeric code comprises communicating with a computer or a mobile device over the communication network, an administrator using and located with the computer or the mobile device.

6. The method of claim 5 further comprising updating the database with the second unique alphanumeric code and the second contact information.

7. The method of claim 5 wherein the administrator does not know the identity of the user.

8. The method of claim 1 wherein providing the second alphanumeric code and the second contact information associated with the second alphanumeric code comprises sending an electronic message with the second alphanumeric code and the second contact information to the user over the communication network.

9. The method of claim 1 wherein providing the second alphanumeric code and the second contact information comprises outputting the second alphanumeric code and the second contact information automatically after instructions to associate the first unique alphanumeric code with a second unique alphanumeric code are received.

10. The method of claim 1 wherein the communication network comprises a computer network.

11. The method of claim 1 wherein the communication network comprises a mobile phone network.

12. The method of claim 1, wherein the first or the second contact information is provided in a vCard format.

13. A method of managing employee contact information, comprising:
providing a first unique alphanumeric code associated with contact information for a first employee;
receiving information regarding the duties of the first employee and a second employee; and
causing a search for the first unique alphanumeric code to be redirected to a second unique alphanumeric code associated with contact information for the second employee.

14. The method of claim 13 further comprising causing the second unique alphanumeric code and contact information for the second employee to be sent to a user who had previously requested contact information associated with the first unique alphanumeric code.

15. The method of claim 14 wherein the second employee assumes duties of the first employee.

16. A computer system for managing contact information, comprising:
a processor; and
storage containing instructions that, when executed by the processor, cause the computer system to:
receive a first unique alphanumeric code from a user over a communication network;
access a database to identify first contact information associated with the first unique alphanumeric code;
provide the first contact information to the user over the communication network;
receive instructions to associate a second unique alphanumeric code with the first unique alphanumeric code; and
provide the second unique alphanumeric code and second contact information associated with the second unique alphanumeric code to the user over the communication network.

17. The computer system of claim 16 wherein the storage additionally contains instructions that cause the computer system to compare the first unique alphanumeric code to a plurality of unique alphanumeric codes stored in the database.

18. The computer system of claim 16 wherein the instructions that cause the computer system to provide the first contact information cause the computer system to send an electronic message with the first contact information to the user over the communication network.

19. The computer system of claim 16 wherein the instructions that cause the computer system to provide the second unique alphanumeric code and the second contact information cause the computer system to send an electronic message with the second unique alphanumeric code and the second contact information to the user over the communication network.

20. The computer system of claim 16 wherein the storage additionally contains instructions that cause the computer system to output automatically the second unique alphanumeric code and the second contact information to the user after instructions to associate the second unique alphanumeric code with the first unique alphanumeric code are received.

21. The computer system of claim 16 wherein the computer system communicates with a computer or a mobile device over the communication network, the user using and being located with the computer or the mobile device.

22. The computer system of claim 21 wherein the computer comprises a web browser and the storage comprises instructions to receive a unique alphanumeric code from the web browser.

23. The computer system of claim 21 wherein the mobile device comprises an application and the storage comprises instructions to receive a unique alphanumeric code from the application.

24. A method of distributing contact information, comprising:
receiving a first unique alphanumeric code from a user over a communication network;
accessing a database to identify first contact information associated with the first unique alphanumeric code;
providing the first contact information to the user over the communication network until instructions are received to associate the first unique alphanumeric code with a second unique alphanumeric code; and
if instructions are received to associate the first unique alphanumeric code with a second unique alphanumeric code, then providing the second alphanumeric code and second contact information associated with the second alphanumeric code to the user over the communication network.
